(19) United States
(12) Patent Application Publication
(10) Pub. No.: US 2015/0158595 A1
(43) Pub. Date: Jun. 11, 2015

(54) AIRCRAFT THROTTLE CONTROL SYSTEM WITH AN EMITTER UNIT AND A RECEIVER UNIT

(71) Applicant: Airbus Operations (S.A.S.), Toulouse (FR)

(72) Inventors: Bernard Guering, Montrabe (FR); Laurent Saint-Marc, Montaigut Sur Save (FR)

(21) Appl. No.: 14/559,187

(22) Filed: Dec. 3, 2014

(30) Foreign Application Priority Data
Dec. 4, 2013 (FR) 1362083

(51) Int. Cl. B64D 31/04; G05G 1/04

(52) U.S. Cl. CPC B64D 31/04; G05G 1/04

(57) ABSTRACT

An aircraft throttle control system having a control lever. The control system comprises an emitter unit having the pivot-mounted control lever and a receiver unit having a pivot-mounted lever, and a linkage connecting the control lever to the lever, and transmitting movement between the control lever and the lever. That makes it possible to optimize the space in a flight deck and typically makes it possible to dispense with the central pedestal generally present in the middle of flight decks while at the same time maintaining conventional ergonomics for controlling the throttle for example. A flight deck element is also disclosed having a fixed structure to which the control system is rigidly connected, to an associated flight deck and to an aircraft equipped with such a flight deck.

### CROSS-REFERENCE TO RELATED APPLICATION

This application claims priority to French Patent Application No. 1362083 filed Dec. 4, 2013, the entire disclosure of which is incorporated by reference herein.

### TECHNICAL FIELD

The disclosure herein relates generally to an aircraft throttle control system. More particularly, the disclosure herein is applicable to a civil transport aircraft, particularly to a commercial aircraft transporting passengers, luggage and/or goods. The flight deck, usually referred to as the cockpit, is the space reserved for the pilots. It contains all the controls (engine controls referred to as throttle controls, controls for actuating the control surfaces and high-lift flaps, controls for actuating the landing gear, the air brakes, etc.) and the instruments necessary for flying the plane.

### BACKGROUND

A flight deck of an aircraft, notably a civil transport airplane, generally has two seats positioned roughly symmetrically one on each side of a central axis of the flight deck. A pedestal 1 as depicted in FIG. 1 which corresponds to the known prior art is positioned between the two seats. The pedestal extends the central part of the instrument panels 2 which are situated level with the pilots along the axis of the flight deck. This assembly has the particular feature of being accessible to and used by both pilots. It comprises equipment of an electrical and electronic nature (display and control panels) and mechanical equipment comprising one or more mechanical control systems associated with the flight controls. Typically, the pedestal 1 comprises the control levers 3 that control the power of the engines (or other propulsion) referred to as throttle control levers, and other control levers typically for controlling the air brakes, for deploying the flaps and slats, and for adjusting the horizontal plane, etc.

The pedestal thus comprises two subassemblies, generally referred to respectively as the electrical pedestal and the mechanical pedestal.

A conventional pedestal 1 represents a significant volume to fit into a flight deck at the design stage. The volume occupied by the pedestal 1 is central, because the pedestal is used by the pilots situated one on either side. This volume extends down to the floor 4 of the flight deck, on which the pedestal 1 generally rests. As a result, the pedestal impedes the pilots in getting into their respective seats. This is why the pilot seats can generally be moved back over a significant distance, and sometimes have complex movement dynamics in order to create access and notably to allow a pilot wishing to sit in or leave his seat to get his legs in or out.

The clearance or empty space needed for moving the seat back entails making the flight deck of the aircraft longer without that additional length being needed for other purposes, thereby correspondingly reducing the space available for aircraft passengers and therefore the number of passengers that can be carried or the comfort in which they can be carried. Now, in general, an aircraft constitutes an environment which is very tight in terms of layout, in which environment any space saving can further assist with achieving a weight saving.

In the context of how flight decks are currently evolving, the electrical pedestal is becoming smaller. This is notably connected with the reduction in the size of the components (for example the thickness of the screens), the increase in computational power for the same size of component, and the possibility that this miniaturization and increase in performance offers for certain functions performed by certain components of the pedestal 1 to be relocated to other parts of the flight deck, notably of the instrument panel 2, and the fact that increasing numbers of functions are currently being incorporated into the same electronic unit allowing more functions to be integrated into a lower total number of units.

Furthermore, flight controls are becoming increasingly automated which means that the control (control levers, switches, etc.) associated with them are no longer needed.

Although these factors do tend towards a simplification and miniaturization of the controls, it is important in the case of certain control levers, for example the throttle control lever 3, to maintain ergonomics which are equivalent or almost equivalent to the current ergonomics.

### SUMMARY

The subject matter herein therefore discloses a mechanical control device for an aircraft flight deck that profits from the way in which flight decks and notably the electronic devices they comprise are evolving in order to allow a spatial optimization while at the same time guaranteeing ergonomics analogous with the present day mechanical control systems.

More specifically, the disclosure herein therefore relates to an aircraft throttle control system comprising a control lever, the system comprising an emitter unit comprising the pivot-mounted control lever and a receiver unit comprising a pivot-mounted lever, and a linkage connecting the control lever to the lever so that a pivoting of the control lever causes a pivoting of the lever.

Breaking the control system down into an emitter unit and a receiver unit makes it possible to optimize the occupation of space, notably vertically, of the control system. It also makes it possible to maintain an unchanged or almost unchanged ergonomics for handling the control lever and to maintain a receiver unit that is structurally similar or near-identical to the control system commonly used in the prior art.

The linkage may comprise or consist of a rigid bar pivot-connected on the one hand to the control lever and on the other hand to the lever.

Advantageously, the four pivot points for the respective pivoting between the control lever and the emitter unit, the lever and the receiver unit, the control lever and the rigid bar, the lever and the rigid bar, form a deformable parallelogram that can be deformed by a pivoting of the control lever so that a rotation of the control lever leads to an identical rotation of the lever. Thus movements of the control lever and of the lever are identical, making the assembly easier to design and making it easy to fit a receiver unit similar or near-identical to the control unit commonly used in the prior art.

The disclosure herein also relates to a flight deck element of an aircraft comprising such a control system as previously defined and a fixed structure, in which the emitter unit and receiver unit are rigidly connected to the fixed structure.

According to one embodiment of the disclosure herein, the emitter unit comprises a first connecting face for connecting with the fixed structure, and the receiver unit comprises a second connecting face for connecting with the fixed structure, and the first and second connecting faces are mutually parallel.

Advantageously, the lever is orthogonal to the second connecting face when the control lever moves into a position orthogonal to the first connecting face. The orthogonal position of the control lever may advantageously correspond to the middle position of its travel. The orthogonal position of the lever may advantageously correspond to the middle position of its travel.

In such a flight deck element, the fixed structure may comprise an instrument panel. A central panel to which the emitter unit is fixed may then advantageously extend the instrument panel.

In one aspect of the disclosure herein, a flight deck of an aircraft comprises such a flight deck element and the control system is a throttle control system.

The flight deck generally also comprises a floor and the space situated between the floor and the emitter unit may be unencumbered. Thus, the legs of a pilot of the aircraft can be situated below the emitter unit and, where appropriate, the central panel. That allows the pilot to leave or return to his seat via the central zone of the flight deck by swinging his legs into the empty space thus created under the panel (and the emitter unit) without the need to move the seat back very far.

A flight deck constituting one aspect of the disclosure herein may comprise a pilot seat and a copilot seat, the control system being positioned between the pilot seat and the copilot seat.

Finally, the disclosure herein also relates to an aircraft comprising such a flight deck. The use of the space in such an aircraft can be optimized typically by reducing the length of the flight deck, because there is no longer any need for the pilot seat to be moved back a long way or moved in a complex manner in order for the pilot to take his seat.

Other specifics and advantages of the disclosure herein will become further apparent from the description which follows.

### BRIEF DESCRIPTION OF THE DRAWINGS

In the attached drawings, given by way of nonlimiting examples:

FIG. 1 schematically depicts the layout, in side view, of the central part of an aircraft flight deck as known from the prior art;

FIG. 2 schematically and in three-dimensions depicts an aircraft throttle control system according to one alternative form of the disclosure herein;

FIG. 3 schematically depicts in side view the control system depicted in FIG. 2;

FIG. 4 schematically depicts in side view a flight deck element according to an alternative form of the disclosure herein, using the control system depicted in FIGS. 2 and 3;

FIG. 5 depicts a three-dimensional view of the flight deck element depicted in FIGS. 4; and

FIG. 6 depicts in a view similar to that of FIG. 1, the layout, viewed from the side, of the central part of an aircraft flight deck implementing an alternative form of the disclosure herein.

### DETAILED DESCRIPTION

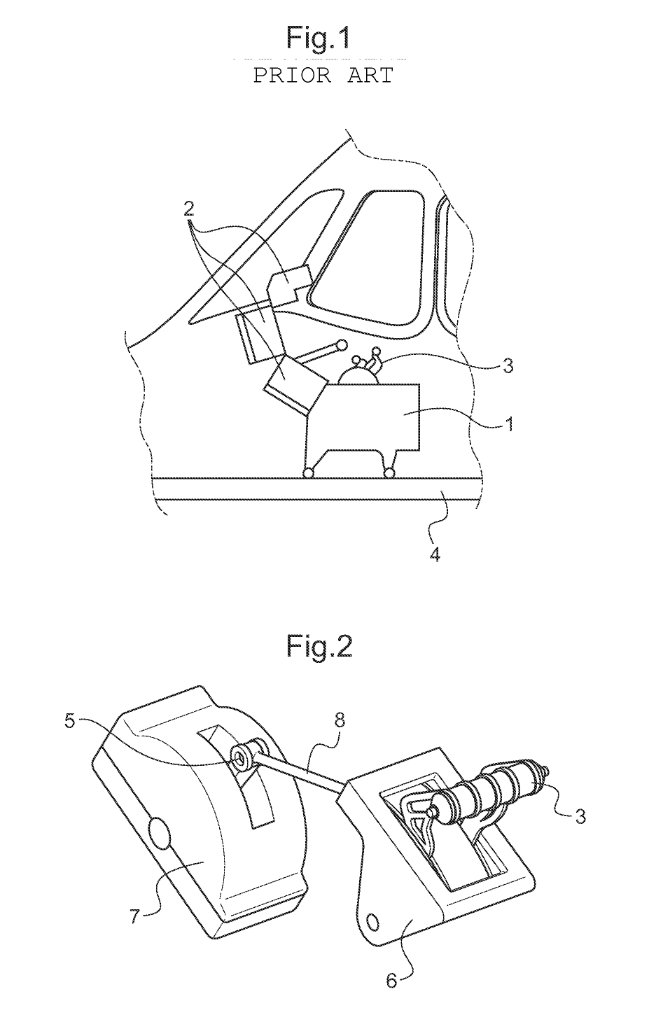

FIG. 2 schematically in three dimensions depicts a mechanical control system according to one alternative form of the disclosure herein. Such a control system comprises an emitter unit 6 and a receiver unit 7. The emitter unit 6 comprises a first control lever 3 which is pivot mounted. This is an aircraft throttle control lever. The receiver unit 7 for its part comprises a pivot-mounted lever 5. A second lever 5 of the receiver unit 7 interfaces with the mechanical and/or electronic systems that control the power of the aircraft propulsion. A linkage 8 allows a movement imparted to the control lever 3 to be transmitted to the lever 5. The pivoting of the lever 5 brought about by the pivoting of the control lever 3 may be identical to the pivoting of the control lever 3. In other words, according to one configuration of the linkage 8, a rotation of the control lever 3 by N degrees in a given direction may cause the lever to rotate by N degrees in the same direction.

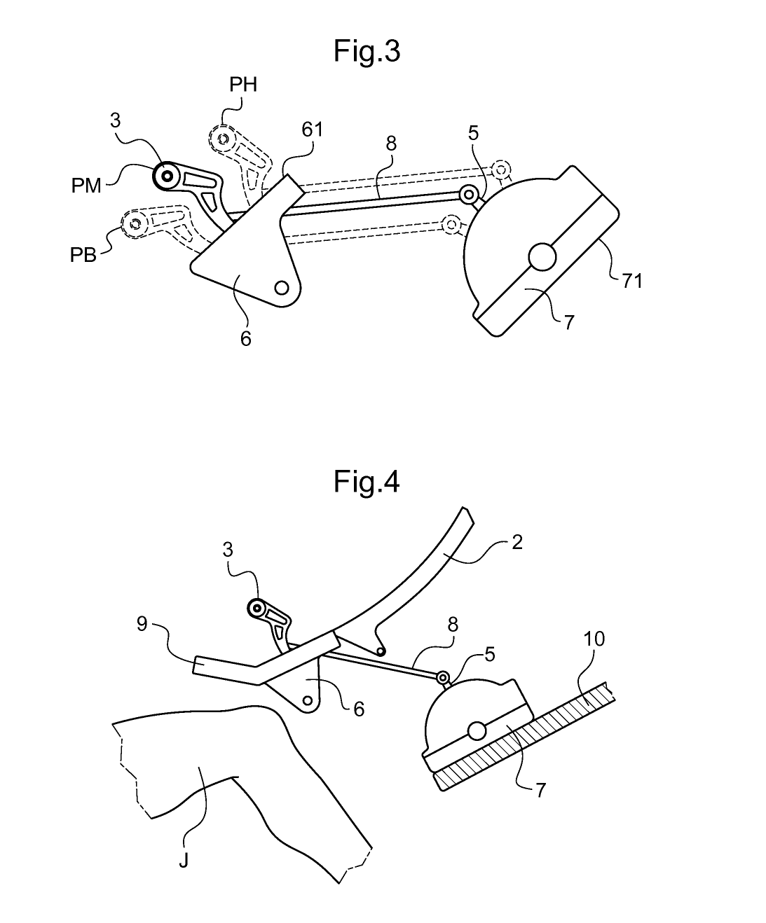

FIG. 3 schematically depicts, in a side view, namely a view at right angles to the plane of pivoting of the control lever 3, the control system depicted in FIG. 2. Three positions of the control lever 3 are depicted in the same figure: a high position PH, a middle position PM, and a bottom position PB. In the exemplary embodiment depicted here, the movement is transmitted identically, without demultiplication, between the control lever 3 and the lever 5. For that, the distance between the pivot connecting the control lever 3 and the emitter unit 6 on the one hand, and the pivot connecting the control lever 3 and the linkage 8 on the other, is equal to the distance between the pivot connecting the lever 5 and the receiver unit on the one hand, and the pivot connecting the lever 5 and the linkage 8 on the other. The linkage 8 here is a rigid bar. Thus, the four pivot points respectively between the control lever 3 and the emitter unit 6, the lever 5 and the receiver unit 7, the control lever 3 and the rigid bar, and the lever 5 and the rigid bar, form a deformable parallelogram that can be deformed by a pivoting of the control lever 3 so that a pivoting of the control lever 3 causes an identical pivoting of the lever 5.

According to other configurations which have not been depicted, there may be a demultiplication and/or an inversion in the direction of rotation between the control lever 3 and the lever 5. A demultiplication can be obtained by adopting a different distance between the pivot connecting the control lever 3 and the emitter unit 6 on the one hand, and the pivot connecting the control lever 3 and the linkage 8 on the other, and between the pivot connecting the lever 5 and the receiver unit on the one hand, and the pivot connecting the lever 5 and the linkage 8 on the other. An inversion in the direction of rotation between the control lever 3 and the lever 5 may be obtained by, for example, connecting a rigid bar to the control lever by way of linkage 8, on the opposite side (with respect to the pivot of the control lever on the emitter unit) of an actuating zone of the control lever 3. In other words, the pivot about which the control lever pivots is, in that case, situated between that zone of the control lever that the pilot handles and the connection thereof with the linkage 8.

In the example depicted here, the emitter unit 6 comprises a first connecting face 61 intended to be connected to a fixed structure of an aircraft flight deck, and the receiver unit 7 comprises a second connecting face 71 intended to be connected to a fixed structure of an aircraft flight deck. Once mounted on a suitable fixed structure, the first and second connecting faces 61, 71 are mutually parallel. That greatly simplifies the geometric design of the control and of the flight deck.

When the control lever 3 is in the middle position PM, the lever 5 is also situated in a middle position. The middle position typically corresponds to the position midway between a far bottom position (which may correspond to minimum thrust from the aircraft propulsion) and a most high position (which may correspond to maximum thrust from the aircraft propulsion). In the preferred example depicted here, the control lever 3 in the middle position is orthogonal to the first connecting face 61. As the control lever may have a complex shape, its orthogonal nature is assessed in terms of the orthogonality of the axis connecting the center of the pivot between the control lever 3 and the emitter unit 6 to the center of the pivot between the control lever 3 and the linkage 8 with respect to the first connecting face 61. In the preferred example depicted here, the lever 5 in the middle position is orthogonal to the second connecting face 71. The orthogonal nature is assessed in terms of the orthogonality of the axis connecting the center of the pivot between the lever 5 and the receiver unit 7 to the center of the pivot between the lever 5 and the linkage 8 with respect to the second connecting face 71.

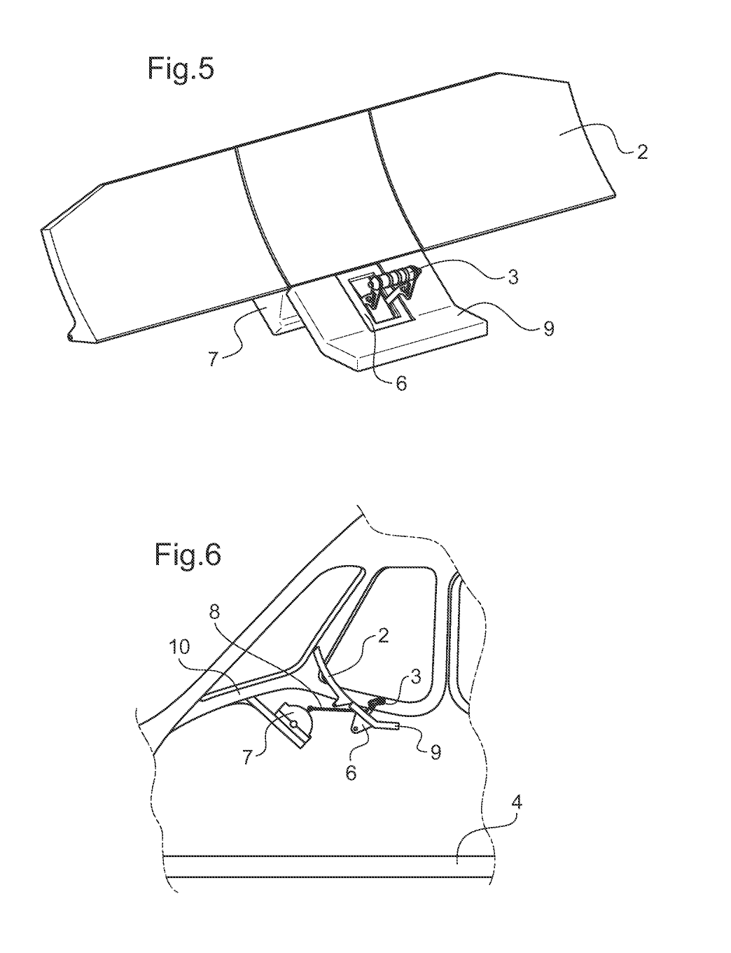

FIGS. 4 and 5 schematically depict, in two different views, a flight deck element according to an alternative form of the disclosure herein, employing the control system depicted in FIGS. 2 and 3. The flight deck element comprises an instrument panel 2, here depicted in part. The instrument panel 2 may, for example, comprise display screens. In a central part, a panel 9, which may bear a certain number of control devices, is positioned contiguous with the lower part of the instrument panel 2 that it extends. Positioned in this way, the control devices that the panel 9 bears are readily accessible to the pilot or pilots of the aircraft. The panel 9 is fixed, and therefore forms part of a fixed structure 10 of the flight deck. The emitter unit 6 may be fixed to the panel 9, typically across it. The receiver unit 7 is fixed to the fixed structure 10 of the flight deck. Furthermore, the panel 9 is advantageously configured in such a way as to leave sufficient clear space between the floor 4 and the underside of the panel that the pilot or pilots can get into or out of their respective seat easily. Typically, the panel 9 may have a first segment for connection to the instrument panel 2, which extends the plane or curvature of the instrument panel, and a substantially horizontal second segment offering a surface suited to the installation of controls which are thus very easy to access.

FIG. 4 schematically depicts a leg J of the pilot of the aircraft when he is seated in his seat, at the flight controls. The leg J is below the level of the panel 9, and that allows a pilot wishing to leave his seat to twist, swinging his legs under the panel 9 and the emitter unit 6. The pilot can then leave his seat via the central part of the flight deck. Thus, contrary to what happens in an aircraft comprising a central pedestal in its flight deck, there is no need to allow the pilot seat to move back a great deal in order for the pilot or pilots to get his or their legs out from under the instrument panel. That makes it possible to reduce the size of the flight deck or to assign the space thus gained to other equipment.

FIG. 6 depicts, in a view similar to that of FIG. 1, the arrangement viewed from the side of the central part of an aircraft flight deck implementing an alternative form of the disclosure herein. The flight deck partially depicted in FIG. 6 more particularly implements a flight deck element as depicted in FIGS. 4 and 5. In the flight deck depicted here, the central zone between the floor 4 and the instrument panel 2 is largely unencumbered, whereas the flight deck element used and in accordance with one embodiment of the disclosure herein also makes it possible to maintain ergonomics, typically throttle control, analogous to the ergonomics proposed in the prior art.

Finally, the disclosure herein makes it possible, where desired, for the control lever 3 to be positioned higher up and more vertically than in the prior art. Such a position makes it easier for the pilot to see the position of the control lever 3.

While at least one exemplary embodiment of the present disclosure has been shown and described, it should be understood that modifications, substitutions and alternatives may be apparent to one of ordinary skill in the art and can be made without departing from the scope of the disclosure described herein. This application is intended to cover any adaptations or variations of the specific embodiments discussed herein. In addition, in this disclosure, the terms “comprise” or “comprising” do not exclude other elements or steps, and the terms “a” or “one” do not exclude a plural number. Furthermore, characteristics or steps which have been described with reference to one of the above exemplary embodiments may also be used in combination with other characteristics or steps of other exemplary embodiments described above.

1. An aircraft throttle control system comprising a pivot-mounted first control lever, an emitter unit that comprises the first control lever, and a receiver unit that comprises a pivot-mounted second lever, and a linkage connecting the first control lever to the second lever so that pivoting of the first control lever causes pivoting of the second lever.

2. The control system according to claim 1, wherein the linkage comprises a rigid bar pivot-connected to the first control lever and to the second lever.

3. The control system according to claim 2, wherein four pivot points for respective pivoting between the first control lever and the emitter unit, the second lever and the receiver unit, the first control lever and the rigid bar, the second lever and the rigid bar, form a deformable parallelogram that is deformable by pivoting of the first control lever so that a rotation of the first control lever leads to an identical rotation of the second lever.

4. An aircraft flight deck element comprising a control system according to claim 1 and a fixed structure, wherein the emitter unit and receiver unit are rigidly connected to the fixed structure.

5. The flight deck element according to claim 4, wherein the emitter unit comprises a first connecting face for connecting with the fixed structure, and the receiver unit comprises a second connecting face for connecting with the fixed structure, and in which the first and second connecting faces are mutually parallel.

6. The flight deck element according to claim 5, wherein the second lever is orthogonal to the second connecting face when the first control lever moves into a position orthogonal to the first connecting face.

7. The flight deck element according to claim 4, wherein the fixed structure comprises an instrument panel.

8. The flight deck element according to claim 7, comprising a central panel to which the emitter unit is fixed and which extends the instrument panel.

9. An aircraft flight deck comprising a flight deck element according to claim 4, and in which the control system is a throttle control system.

10. The flight deck according to claim 9, the flight deck further comprising a floor wherein the space situated between the floor and the emitter unit is unencumbered.

11. The flight deck according to claim 9, comprising a pilot seat and a copilot seat, the control system being positioned between the pilot seat and the copilot seat.

12. An aircraft comprising a flight deck according to claim 9.
